(19) United States
(12) Patent Application Publication
(10) Pub. No.: US 2007/0136206 A1
(43) Pub. Date: Jun. 14, 2007

(54) System for intellectual property trading

(76) Inventor: Alfred C. Kwok, San Jose, CA (US)

Correspondence Address: PARSONS HSUE & DE RUNTZ LLP, 595 MARKET STREET, SUITE 1900, SAN FRANCISCO, CA, 94105, US

(21) Appl. No.: 11/601,299

(22) Filed: Nov. 17, 2006

Related U.S. Application Data
(60) Provisional application No. 60/738,134, filed on Nov. 17, 2005.
(60) Provisional application No. 60/782,613, filed on Mar. 14, 2006.

(51) Int. Cl. G06Q 99/00

(52) U.S. Cl. 705/54

(57) ABSTRACT

The risks encountered by a buyer of intellectual property rights are reduced by an intellectual property rights audit process by which the intellectual property rights of a seller undergoes the audit where the seller is assisted by an intellectual property rights listing agent. To reduce the risks to the seller of intellectual property rights, the buyer undergoes an intellectual property protection audits and the assistance of an intellectual property rights acquisition agent. An escrow may be established between the buyer and seller of the intellectual property rights with the assistance of an escrow agent for implementing an intellectual property trading agreement. The above processes may be carried out by means of a web portal. The web portal preferably keeps an activity log of all the transactions between the various parties involved in a manner that reduces the chances of tampering.

### CROSS-REFERENCE TO RELATED APPLICATIONS

This application claims priority to U.S. Provisional Application No. 60/738,134 of Alfred C. Kwok, entitled “System for Intellectual Property Trading,” filed on Nov. 17, 2005, and U.S. Provisional Application No. 60/782,613 of Alfred C. Kwok, entitled “Lower Risk SIP Trading Infrastructure,” filed on Mar. 14, 2006, which applications are incorporated herein in their entirety by this reference.

### BACKGROUND

This invention relates in general to trading systems, and in particular to a system for intellectual property trading.

The following acronyms are used herein, and in the figures of this application.

| | |
|---|---|
| IP | Intellectual Property |
| SIP | Semiconductor Intellectual Property |
| IPO | Initial Public Offering |
| IPL | Intellectual Property Listing |
| ROI | Return on Investment |
| M&A | Mergers & Acquisition |
| NDA | Non-Disclosure Agreement |
| RLA | Reference License Agreement |
| REA | Reference Escrow Agreement |
| MOU | Memorandum of Understanding |
| EA | Escrow Agent |
| LA | Listing Agent |
| AA | Acquisition Agent |
| NRE | Non-Recurring Engineering |

IP includes any right or interest in information, trade secret and/or any other proprietary right (protectable by registration or not) in respect of any know-how, technology, concept, idea, invention, data, program, drawing, schematic diagrams, netlists, program, mask works, semiconductor topography rights, database rights, utility model, brand, design, system, process, logo, mark, style or other thing, domain names, trade and business names and all goodwill associated with such names, conceived, used, developed or produced by any person and all rights of a similar nature in any part of the world, including without limitation all copy right and mask work of, and patents issued to and/or patent applications.

IP trading, or IP rights trading, refers to the buying and selling of IP rights in any form, including the selling and buying of IP ownership rights, and any form of licensing, whether exclusive or non-exclusive. A buyer of IP, or of IP rights, refers to a party which acquires IP rights in any form. Thus a buyer can be a party who acquires ownership of IP rights or a party who acquires a license (exclusive or non-exclusive) of any form to the IP rights. A seller of IP, or of IP rights, refers to a party who transfers IP rights to another party, either as an outright sale and transfer of ownership, or a party that transfers licensing rights (exclusive or non-exclusive) to another party.

Although the IP market is growing reasonably well, it is nowhere the size that has been projected. One issue encountered by the IP market is the high risk involved in IP transactions for both buyers and sellers. For the buyers there is the technical issue that the IP will not readily integrate and/or have the required functionality. On the business/legal side, the IP of interest to the buyer may infringe patents, trademarks, copyrights, mask work rights or misappropriate trade secrets of others or worse, has not been fully developed by the seller. For the sellers (except for “star IP”) the prices and volumes for IP are too low to sustain a healthy business—due to the high risks associated with third party IP—and worse that their IP will be outright stolen.

The sale of ownership of IP rights and licensing of such rights have been widespread. However, potential sellers of IP rights may not have adequate channels for marketing such rights and potential buyers may not be aware of all of the IP rights that may be available. Thus potential sellers and buyers typically resort to industry contacts that they have or through informal channels such as through being active in trade associations.

None of the above described forms of IP rights trading is entirely satisfactory. It is therefore desirable to provide an improved trading platform for IP rights, in which the above-described difficulties are alleviated.

### SUMMARY

In order to reduce the risks in IP rights trading, in one embodiment, it may be desirable for IP rights that are to be sold to be subjected to an intellectual property rights audit, and to engage an intellectual property rights listing agent as advisor. Preferably, these features are implemented through a web portal and a network between a server computer hosting the web portal, a seller computer operated by or on behalf of a seller and at least one listing agent computer. The seller computer communicates with the at least one listing agent computer to engage an intellectual property rights listing agent and supplies information for an intellectual property rights audit. The seller computer receives an intellectual property rights audit report. This report then establishes a benchmark useful for assessing the risks involved in buying the intellectual property rights.

In another embodiment, the process for the intellectual property rights audit can be performed by means of a server computer hosting a web portal that is used to facilitate the audit process. Thus to enable a seller to select one of a number of listing agents, the server computer supplies profiles of listing agents in response to a request from the seller computer. The server computer supplies an intellectual property rights legal criteria questionnaire to the seller computer. After a listing agent has been engaged by the seller, information provided by the seller computer in response to the questionnaire is then supplied by the server computer to the selected listing agents.

In one more embodiment, to reduce the potential risks to potential sellers of IP rights, potential buyers of such rights may be qualified through an intellectual property protection audit process and the assistance of an acquisition agent. Thus a buyer computer communicates with at least one acquisition agent computer to engage an intellectual property rights acquisition agent. The buyer computer supplies information for an intellectual property protection audit. In return, the buyer computer receives an intellectual property protection audit report. This audit report then establishes a benchmark by which the risks involved in proceeding with IP trading with the buyer can be assessed.

In yet another embodiment, a server computer hosting a web portal may be used to assist the qualification process for the buyer. To assist the selection of an acquisition agent, in response to request from the buyer computer, the server computer supplies profiles of acquisition agents and supplies an intellectual property protection questionnaire to the buyer computer. After an acquisition agent has been engaged and after information has been provided by the buyer computer in response to the questionnaire, the server computer may then supply the selected acquisition agent with the information provided by the buyer computer in response to the questionnaire.

Different from other types of trading, in some transactions, IP trading may involve a complicated process during which the performance of both the buyer and the seller will need to be monitored to assure that both parties perform adequately. For this purpose, in one embodiment, an escrow agent is utilized. In addition, the seller of the IP rights will provide a prospectus for the IP for review by the buyer. Thus after an IP has been identified to be of interest, the computer operated by or on behalf of a buyer communicates with a computer operated by or on behalf of a seller to request a prospectus for the intellectual property. The two computers then communicate concerning the signing of a trading agreement involving the intellectual property between the buyer and seller and the signing of an escrow agreement between the seller, buyer and an escrow agent for implementing the trading agreement.

In yet another embodiment, the escrow process may be assisted by an escrow agent computer operated by or on behalf of an escrow agent. After a trading agreement involving the intellectual property between the seller and buyer has been signed, the escrow agent computer communicates with the buyer computer and the seller computer (and optionally also an acquisition agent computer and a listing agent computer) concerning the signing of an escrow agreement between the seller, buyer and escrow agent for implementing the trading agreement. After the escrow agreement has been signed, and after at least one escrow payment is received from the buyer, the escrow agent computer provides a verifying notice of receipt of the payment. After the buyer computer acknowledges that a milestone requirement regarding transfer of rights to the intellectual property has been met and after at least one escrow payment is received from the buyer, the escrow agent computer authorizes release of at least part of an escrow payment from the buyer.

In yet one more embodiment, a computer system may be used to enable intellectual property trading. The computer system comprises a database containing information on intellectual property listings, sellers or their representatives, and reference license and escrow agreements.

All patents, patent applications, articles, books, specifications, standards, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIG. 1 is a simplified view of an exemplary client-server environment in which SIP trading may take place to illustrate one embodiment of the invention.

FIG. 2 is traced an implementation of the environment of FIG. 1 that illustrates in more detail the files in the server computer and connections between the server computer and the client computers.

FIG. 3 is an example of a computer system for implementing server computer and client computers in one embodiment of the present invention.

FIGS. 4-8 are a flow chart illustrating a seller listing process.

FIGS. 9-12 are a flow chart illustrating a buyer qualification process.

FIGS. 13-15 form a flow chart illustrating an IP transfer and payment process.

Identical components are illustrated by the same numerals in this application.

### DETAILED DESCRIPTION OF EXEMPLARY EMBODIMENTS

Embodiments of the invention are illustrated in regard to the trading of intellectual property used in the semiconductor industry, or in the trading of SIP. It will be understood, however, that the features of the embodiments described below are also applicable to the trading of intellectual property that is not in the semiconductor arena. All such variations and applications are within the scope of the invention.

The new paradigm proposed is an embodiment including an enhanced ecosystem to support SIP trading. The proposed major enhancement in this embodiment to the existing environment is the addition of enabling third parties to substantially reduce risk by enforcing preferably full disclosure of important technical and business/legal details for buyers and sellers and to assure proper payments upon completion of contracted milestones.

On the SIP provider side in one implementation of the embodiment, there are Listing Agents and technical assessors to help SIP development companies understand what they need to do to make good SIP available both from technical and legal points of view; to confirm that they do so as a condition to “list” their SIP; and to assure a potential buyer that proper IP protection practices were applied by the SIP provider to create the SIP listed.

On the SIP buyer side in another implementation of the embodiment, Acquisition Agents and Technical Assessors help buyers do effective due diligence on their potential SIP purchases. This is from:
a technical perspective: functionality, complete deliverables and quality;
a legal perspective: patent infringement, originality;
and from a business perspective: supportability, payment incentives.

Preferably both the listing and acquisition agents (brokers for the seller and buyer) are supported by their own Technical Assessors. These experts assist the IP developers to create high quality IP; they can also assist buyers to accurately evaluate the IP quality of a potential acquisition. There are also IP Protection Auditors to assist the buyer to meet proper IP protection requirements and demonstrate to the sellers that these requirements have been met. The brokers themselves preferably are legal professionals, such as members of law firms with experience in IP, so they have the expertise to deal with general legal and business issues.

The technical issues on the buyer's side are associated with integration, functionality and support. The integration issues derive from incorrect or incomplete deliverables. The functionality issues derive from inadequate verification and non-adherence to interface standards. These can be summarized as poor quality. Industry accepted metrics may be adopted for IP transactions.

In some embodiments Escrow Agents are employed who hold payments in escrow, releasing funds as the agreed upon milestones are met. They can work with the brokers to resolve misunderstandings before they become serious disputes.

Escrow Agents insure that payments are made promptly based on achieving negotiated milestones and to proactively resolve misunderstandings between buyers and sellers.

The above mentioned brokers and agents are well positioned to act as first line mediators should problems arise. Should such mediation not be successful, preferably internationally recognized arbitration bodies may be engaged to quickly, inexpensively and impartially arbitrate disputes when they do arise.

In one embodiment as described herein below, only members who have signed membership agreements are permitted to participate in the IP trading. A membership approval process may be used to screen out parties who do not have serious interest in IP trading, and parties who have failed to adopt legitimate business practices. Members can also have rights to seek redress that is not available to non-members. Preferably three types of membership and rules are implemented. A first type is for the trading parties (sellers and buyers) who preferably are members of an IP trading organization. A second type is for the broker and related community (i.e. the listing, acquisition and escrow agents, IP protection auditors). A third type is for other third party enablers, such as technical assessors, design integrators and foundries (as the designated contractor manufacturers by the sellers). In other embodiments, membership is not necessary for participating in IP trading for one or more of the parties referred to above.

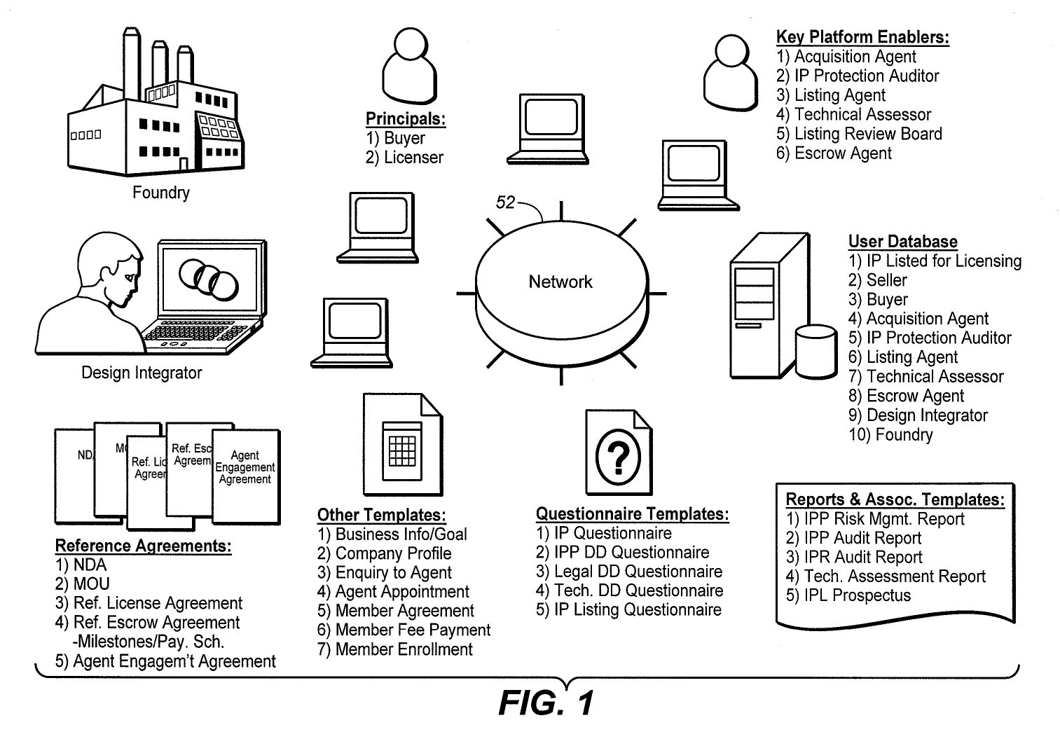

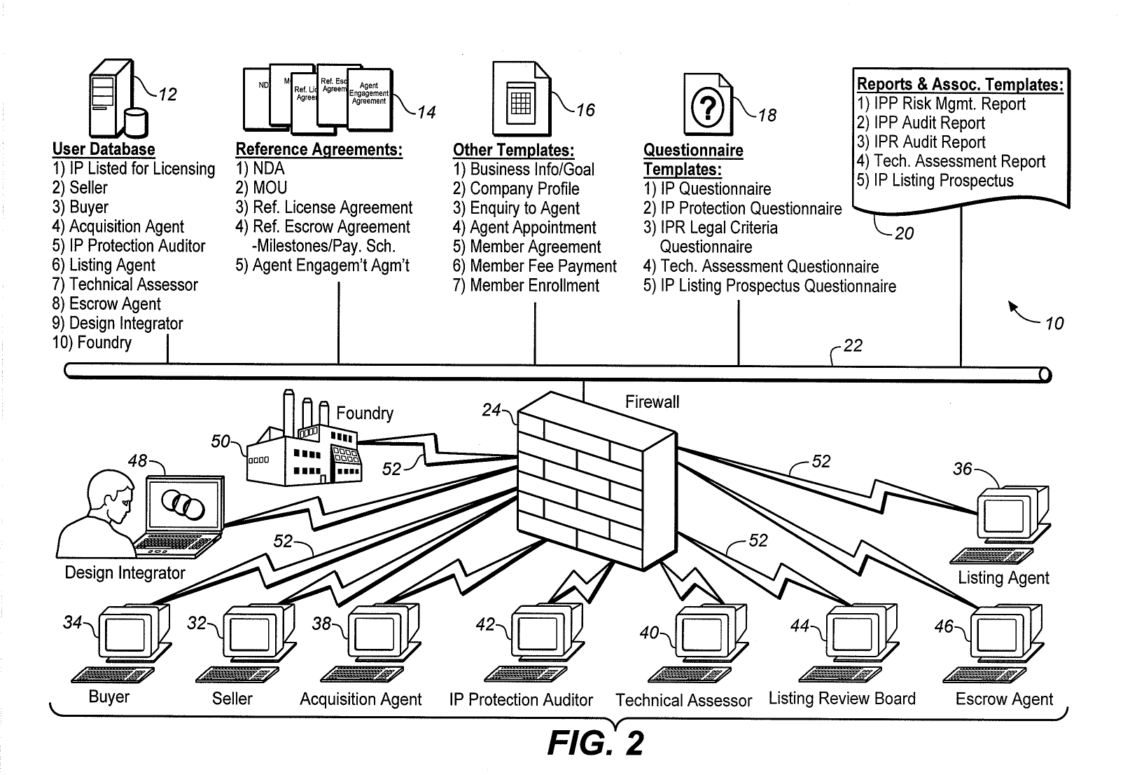

FIGS. 1 and 2 are simplified diagrams of an exemplary client-server environment in which SIP trading may occur. As illustrated in FIG. 2, a server computer 10 may store therein in its memory a user database 12, reference agreements file 14, other templates file 16, questionnaire templates file 18 and reports and associated templates file 20. Server computer 10 also includes a bus 22 and a firewall 24. Server computer 10 is connected to a seller computer 32, a buyer computer 34, a listing agent computer 36, and acquisition agent computer 38, a technical assessor computer 40, an IP protection auditor computer 42, a listing review board computer 44, an escrow agent computer 46, a design integrator computer 48 and a foundry computer 50. As shown in FIGS. 1 and 2, server computer 10 is connected to the client computers through its firewall 24 and network 52. The foundry is generally the mutually-agreed (by both trading parties) contractor manufacturer for the buyer's product(s) embedded with the acquired IP which is specific to a foundry's manufacturing process and design rules. Thus, the foundry, being an enabling partner for the manufacturing of product(s) incorporating the acquired IP, can be the seller's IP protection partner to stop the manufacturing of any product misusing the seller's IP.

The user database 12 contains a listing of IPs available for licensing, the names and profiles for a number of acquisition agents, the names and profiles of a number of listing agents, the names and profiles of a number of IP protection auditors, the names and profiles of a number of technical assessors, the names and profiles of a number of escrow agents, and the names and profiles of design integrators and foundries. Database 12 also contains information on buyers and sellers, their IDs and passwords.

The reference agreements file 14 contains NDA, MOU, reference license agreements, reference escrow agreements and a milestone/payment schedule template as an attachment to the reference escrow agreement. Other templates file 16 contains a template for filling in business information or goals, a template for providing a company profile, a template for inquiry to the above-mentioned agents, a template for appointing one of the above-mentioned agents, a template for a membership agreement, a template for a membership enrollment and a template for payment of membership fee.

The questionnaire templates file 18 includes many different templates, which include templates for an IP questionnaire, an IP protection questionnaire, an intellectual property rights (legal criteria) questionnaire, a technical questionnaire and an IP listing prospectus questionnaire. The reports and associated templates file 20 includes the IP protection (IPP) risk management reports, IP rights audit reports, IP protection audit reports, technical assessment reports and IP listing prospectus, and the associated templates to generate these reports. The templates listed in FIGS. 1 and 2, however, are only examples and do not form an exhaustive list, and other templates not shown may be included.

In the embodiment of FIGS. 1 and 2, the client computers are not connected to each other, it will be understood that network 52 may also connect the client computers together so that they can communicate with each other directly without going through the server computer 10. All such variations are within the scope of the invention.

While it is possible for the client computers to communicate with each other in the process of IP trading without using the server computer for some of the transactions, it may be preferable for all or most of the transactions to take place through the server computer, so that a record of the activities can be kept and with better safeguards. This facilitates future enforcement of rights of the various parties involved and reduces the possibility of fraud. In one embodiment, the transactions involving SIP trading are carried out via a web portal hosted by the server computer 10. All clients who wish to access the web portal will need to have a user name or ID (“user name” and “user ID” are used interchangeably herein below) and computers used by such users also will have their own names or IDs, where a designated console is for a designated user. Each user preferably has his or her own password. The user ID and password may be designated when the user logs in the web portal for the first time, and the user ID and password are then stored in the user database.

Security measures may also be provided in one embodiment as described below. In the user database 12 in the server computer 10, each of the repeat users of the web portal will have his or her own ID and password, where the password will indicate the type of rights possessed by the corresponding user. Thus some user may have read and write access rights to particular documents in the server computer 10 while other users may have read only rights to these documents. Typically when a party is requested to provide information by responding to a template, the template document can typically be altered by such party. This applies to the templates in templates 16 and 18, for example. The reports issued according to the report templates 20, however, are typically not alterable once issued; no user may alter it and users typically only have read only rights in regard to these reports. Server computer 10 preferably records all user activities on a time basis in the background in a manner transparent to the users and clients. The activities may be recorded by keystrokes, execution commands, input “text” and output templates/screens. The above activities are recorded in an activity log. Preferably the record of the monitored activities in the activity log is one time write only, so that the record cannot be altered after it has been written. Preferably all the activities at the web portal are monitored and recorded in a centralized location such as by the server computer 10. All of the user activities are recorded and identified by user IDs and machine IDs.

When documents are to be printed or forwarded by client computer, the document to be printed or forwarded is first converted by the server computer into an image file so that it is difficult to be altered. Furthermore, the image file that is being printed or forwarded is watermarked with embedded unique traceable ID, such as the ID of the user or machine of the client computer requesting the image file and from which computer the image file is being printed or forwarded. This watermarking is performed by the server computer and not by the client computer. The security provisions are summarized in the outline below.

Security Provisions:
1. Access control (on need-to-access basis):
   a) Individual ID/access level allowance
      i. The designated corporate account administrator set up the access control for a limited number of allowed individual employees (on need-to-access basis) within his/her own company (with a unique corporate ID).
      ii. Individual biometric data input devices like thumbprint sensor can be integrated for access control.
   b) Machine ID/alternative machine allowance
      i. That ties together with a specific individual user ID.

Normally, one user ID to one Machine ID—a designated console for a designated user.
ii. No single machine for multiple users is allowed without proper corporate administration approval (each corporate account manage its own security overrides).
iii. Except the account administrator, a user can use only one machine (console) for access, unless approved otherwise.
c) System lock-up after repeated (>5 times) failing attempts to access
   i. Only account administrator can unlock the lock-up after filing the report on-line from his/her own designated console.
d) Different access level controls:
   i. Access control to specific templates, databases, reports and reference agreements
   ii. Read only read/write on specific templates (data entry and presentation formats)
   iii. Access control by (1) individual case, individual corporate account (all cases accessible within the same account)
2. Activity log:
   a) Monitor and record all user activities on time base in the background
      i. By key strokes, execution commands, input “text” and output templates/screens
      ii. The record of the monitored activities is one-time-write-only—that is cannot be altered.
      iii. All monitoring tasks are executed on the central server side.
   b) Alert to the pre-determined authorities if repetitive (>3 times) illegitimate attempts to circumvent the security system were detected.
   c) Accessible by the account administrator for a specific corporate account.
3. Watermark with embedded unique traceability ID
   a) The user ID, machine ID (the access terminal/console) and activity log traceability code are to be embedded on any output file as watermark
   b) All output files to personal storage or printer will be converted into an image file with the above traceability.
   c) The watermarking is performed on the server side instead of the console/client side—i.e., at the source
4. Image file print-out
   a) All print-out will be in “pdf” image files instead of editable “text” files

With this embedded watermark on the print-out, the user is reminded that the print-out should be for personal use only and treated as confidential security document and not to be shared with any other person.

In some embodiments, none or only some and not all of the above security features may be adopted, depending on the application intended.

Exemplary Computer System

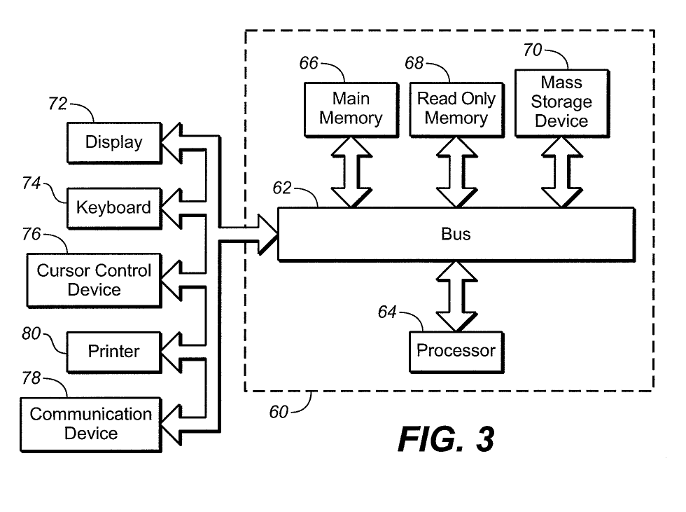

A computer system 60 representing an exemplary server computer or client computer in which features of one embodiment of the present invention may be implemented will now be described with reference to FIG. 3. Computer system 60 comprises a bus or other communication means 62 for communicating information, and a processing device such as processor 64 coupled with bus 62 for processing information. Computer system 60 further comprises a random access memory (RAM) or other dynamic storage device 66 (referred to as main memory), coupled to bus 62 for storing information and instructions to be executed by processor 64. Main memory 66 also may be used for storing temporary variables or other intermediate information during execution of instructions by processor 64. Computer system 60 also comprises a read only memory (ROM) and/or other static storage device 68 coupled to bus 62 for storing static information and instructions for processor 64.

A data storage device 70 such as a magnetic disk or optical disc and its corresponding drive may also be coupled to computer system 60 for storing information and instructions. Computer system 60 can also be coupled via bus 62 to a display device 72, such as a cathode ray tube (CRT) or Liquid Crystal Display (LCD), for displaying information to a computer user. Typically, an alphanumeric input device 74, including alphanumeric and other keys, may be coupled to bus 62 for communicating information and/or command selections to processor 64. Another type of user input device is cursor control 76, such as a mouse, a trackball, or cursor direction keys for communicating direction information and command selections to processor 302 and for controlling cursor movement on display 72.

A communication device 78 is also coupled to bus 62 for accessing other computers through a network (not shown in FIG. 3) such as the Internet, for example. The communication device 78 may include a modem, a network interface card, or other commercially available network interface devices, such as those used for coupling to an Ethernet, token ring, or other type of network. In any event, in this manner, the computer system 60 may be coupled to a number of computers (either client computers and/or server computers) via a conventional network infrastructure, such as a company's Intranet and/or the Internet, for example. A printer 80 is coupled to bus 62 for printing documents for computer 60.

Seller Listing Process

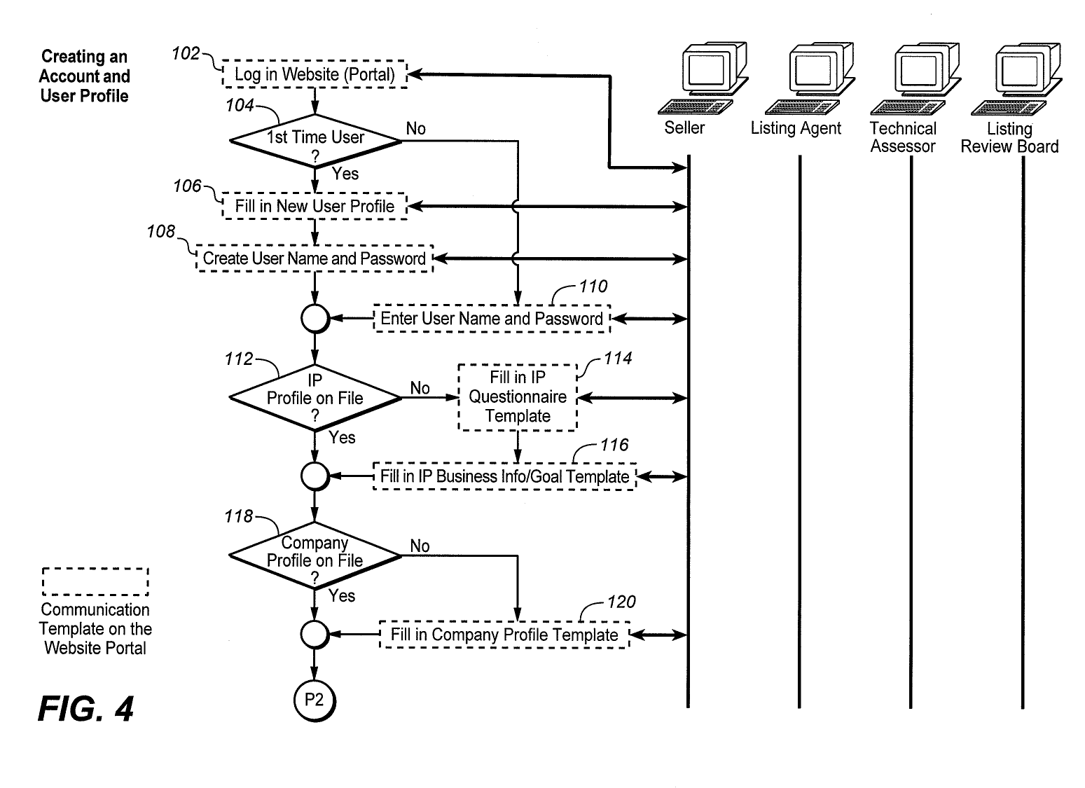

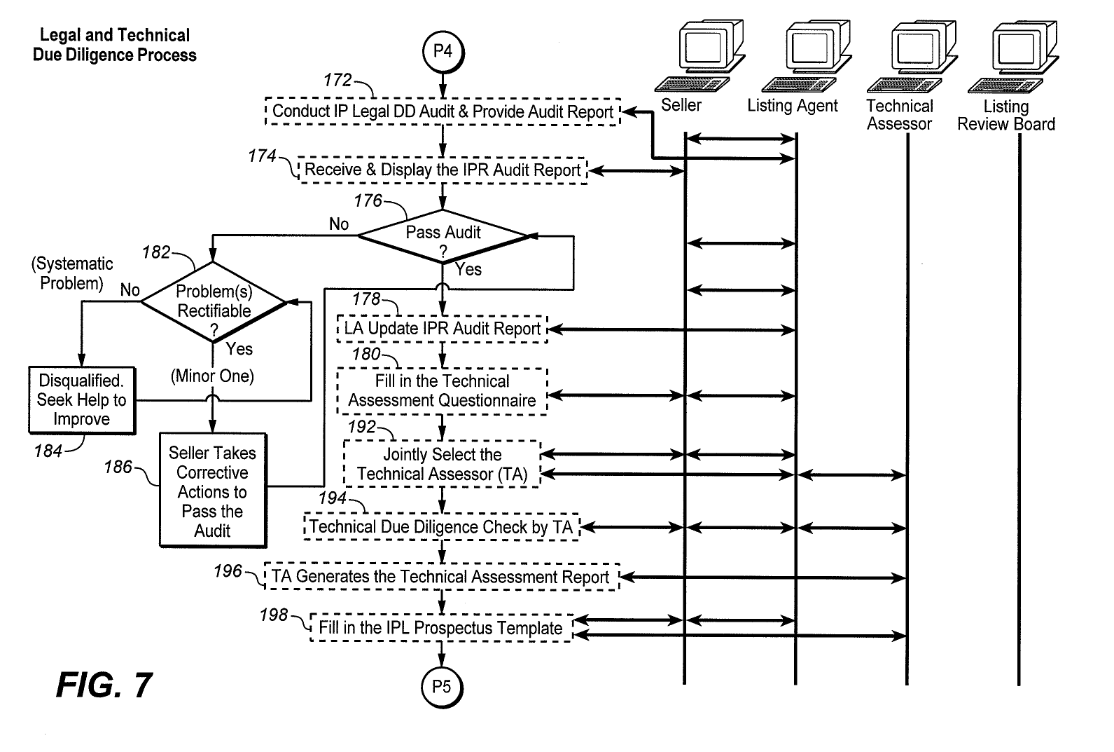

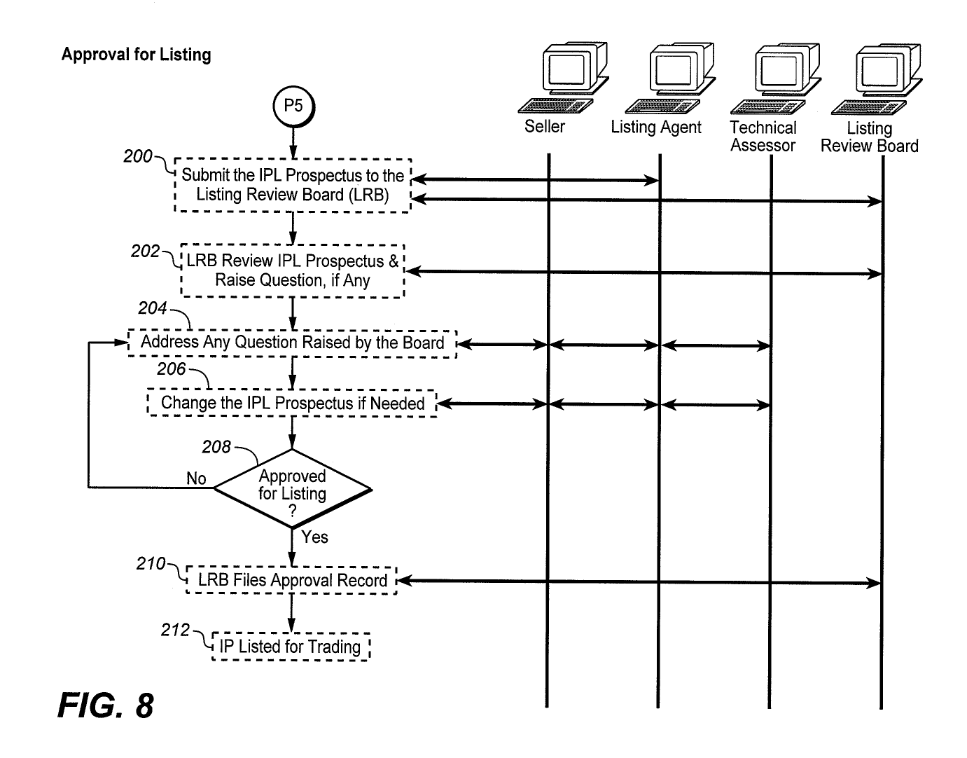

FIGS. 4-8 illustrate a flow chart of a seller listing process. To start the process, the seller first logs into the web portal (block 102) hosted by the server computer 10 by means of the communication template provided by the web portal. In all of the flow charts of this application, a block that has a dark background as in block 102 indicates that a communication template is preferably provided by the web portal. After the seller logs in, the web portal then inquires the user as to whether the user is a first time user (diamond 104). If the user is a first time user, the web portal provides a new user profile template to be completed by the user (block 106). After the user fills in the new user profile template, with a template provided by the web portal, the user creates a user name or ID and password for future access to the web portal (block 108). If the user is not a first time user, then the user is requested to enter the user name or ID and password by means of a template (block 110). The user is then asked whether the user has an IP profile on file (diamond 112). If the user does not have such profile on file, the web portal hosted by the server computer 10 presents an IP questionnaire template to the user for completion (block 114). The user completes the template by filling in the information requested by the template and submits the same to the server computer (block 116).

In the event that the user is representing a seller company which owns the intellectual property to be traded (as indicated by information provided in response to the IP questionnaire template), the web portal on server computer 10 then requests the user to indicate whether the seller company has a profile on file at the web portal (diamond 118). If the seller company does not, the server computer then requests the user to fill in a company profile template (block 120). The company profile is stored in the user database 12 in computer 10. The user representing the seller then proceeds to a process for selecting a listing agent (LA). The user first reviews profiles of the listing agents in the user database 12 of the server computer 10 (block 122). The user selects a listing agent on the list and drafts a letter of inquiry on the portal to the selected visiting agent using one of the templates in template file 16 (blocks 124 and 126). The complete record of the activity of the user is saved in the archives of the portal (block 128), as is the case for all of the activities carried out by users of the web portal. The letter of inquiry is archived and automatically forwarded to the listing agent selected (block 130).

The system then proceeds to a process where the listing agent screens the seller. The listing agent receives the letter of inquiry from or on behalf of the seller (block 132) and reviews the seller information on the portal stored in server computer 10, such as in user database 12 (block 134). The listing agent then interviews the seller either through the portal or in a manner independent of the portal (block 136) and reports back to the web portal. The server computer then inquires the listing agent as to whether the listing agent is willing to take the case (diamond 138). If the listing agent declines the engagement, the listing agent so notifies the seller, preferably through the web portal on server 110 (block 140) and the seller returns to select a listing agent in block 124 (block 142).

If the listing agent accepts the case, attorney-client relationship is established using one of the reference agreements (agent engagement agreement) (block 144). The web portal then inquires the seller as to whether the seller is a full member of the IP trading organization (diamond 146). If the seller is not a full member, the seller then is formally enrolled as a full member (148) using one of the member enrollment templates (block 148). The seller completes the member profile templates and signs the membership agreement using another template from templates file 16 (blocks 150 and 152). The seller then also authorizes membership payment transfer using a template from template file 16 (block 154). The seller is then requested to fill in the IP legal criteria questionnaire from templates 18 (block 156). The listing agent retrieves the information supplied by the seller in response to the questionnaire from the web portal (block 158).

The listing agent then proceeds with a IP legal due diligence audit process and provides a preliminary audit report (block 172). The seller receives and displays or prints the preliminary audit report and reviews the report using the seller computer 32 and a display or printer (block 174). Where computer 60 of FIG. 3 is used to serve as the seller computer, the report may be displayed on display 72 or printed using printer 80. If the preliminary report indicates that the seller passes the audit (diamond 176) the listing agent updates the audit report issued by indicating that it is the final report and the server computer then prompts the seller to fill in a technical assessment questionnaire (blocks 178 and 180).

If the seller fails to pass the audit as indicated in the preliminary audit report, the web portal inquires as to whether the problems identified in the preliminary audit report are rectifiable (diamond 182). If the problems are not rectifiable, the seller is so notified and the process is aborted (block 184). If the problems are rectifiable, corrective measures are taken by the seller with the assistance of the listing agent in order to pass the audit (block 186). After the corrective measures are taken, the server computer again inquires as to whether the seller now passes the audits (diamond 176). If the seller now passes the audit, the listing agent then updates the audit report (block 178) and proceeds to block 180. If the seller still fails to pass the audit, the above process is repeated until the seller passes the audit.

Assuming that the seller passes the audit, the listing agent and the seller jointly select a technical assessor from the lists of technical assessors in database 12 on server computer 10 (block 192). The technical assessor then performs a technical due diligence check on the IP from the seller and generates a technical assessment report (blocks 194 and 196). The seller is then prompted to fill in an IP listing (IPL) prospectus template (block 198). Similar to an underwriter generating an IPO (Initial Public Offering) prospectus for its client to apply for IPO, the listing agent then produces an IPL prospectus based on information provided by the seller and submits the prospectus to the listing review board for review (block 200). The IPL prospectus and the associated legal and technical due diligence processes by independent third parties provide the credibility as well as a fair-market and fact-based assessment of the seller's IP. The IPL prospectus can also be valuable to the IP seller when the IP seller is a candidate for merger and acquisition (M&A) and provides a means by buyers to assess a value for the seller's intellectual assets. The listing review board reviews the prospectus and sends any questions it has to the seller, listing agent or technical assessor (block 202). The seller, listing agent and/or technical assessor address any of the questions raised by the board (block 204) and change the IPL prospectus if needed as a result of the communication with the listing review board (block 206). The server computer then inquires the listing review board as to whether the IPL prospectus is approved for listing (diamond 208). The listing review board files an approval report, and the intellectual property is listed for trading by the server computer 10 (blocks 210 and 212).

If the IPL prospectus is not approved, this means that the listing review board has further questions that have not been addressed by the IPL prospectus and the web portal returns to block 204 to address further questions raised by the board. If the IPL prospectus is approved, then the actions in blocks 210 and 212 are performed as described above. This process may be repeated until the IPL prospectus is approved.

Buyer Qualification Process

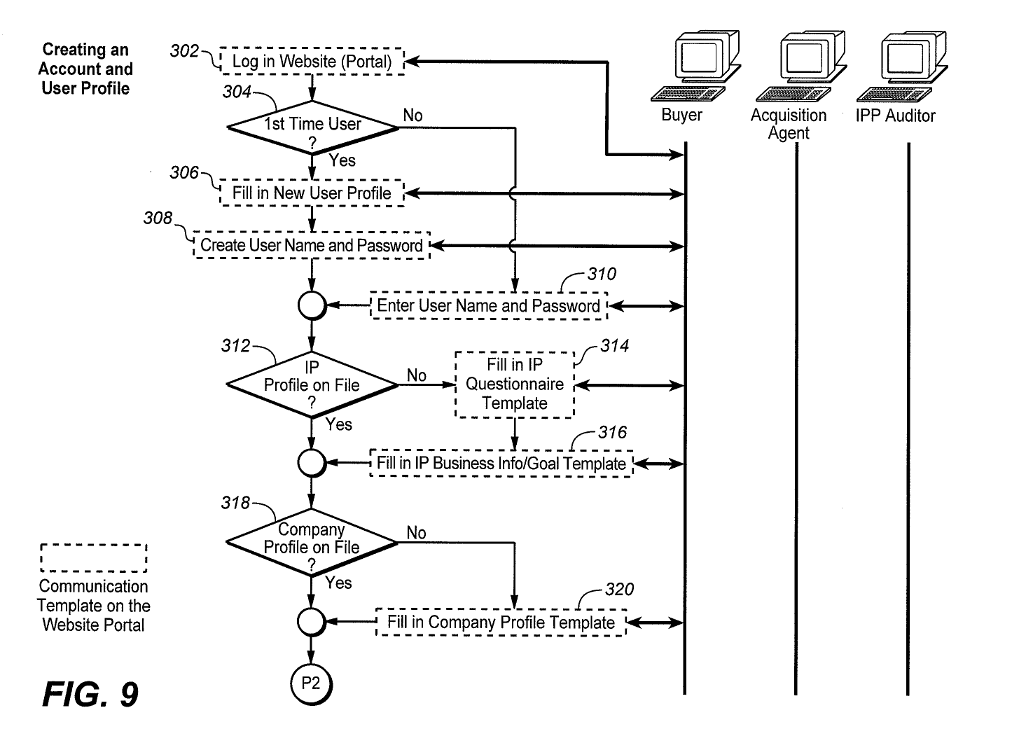

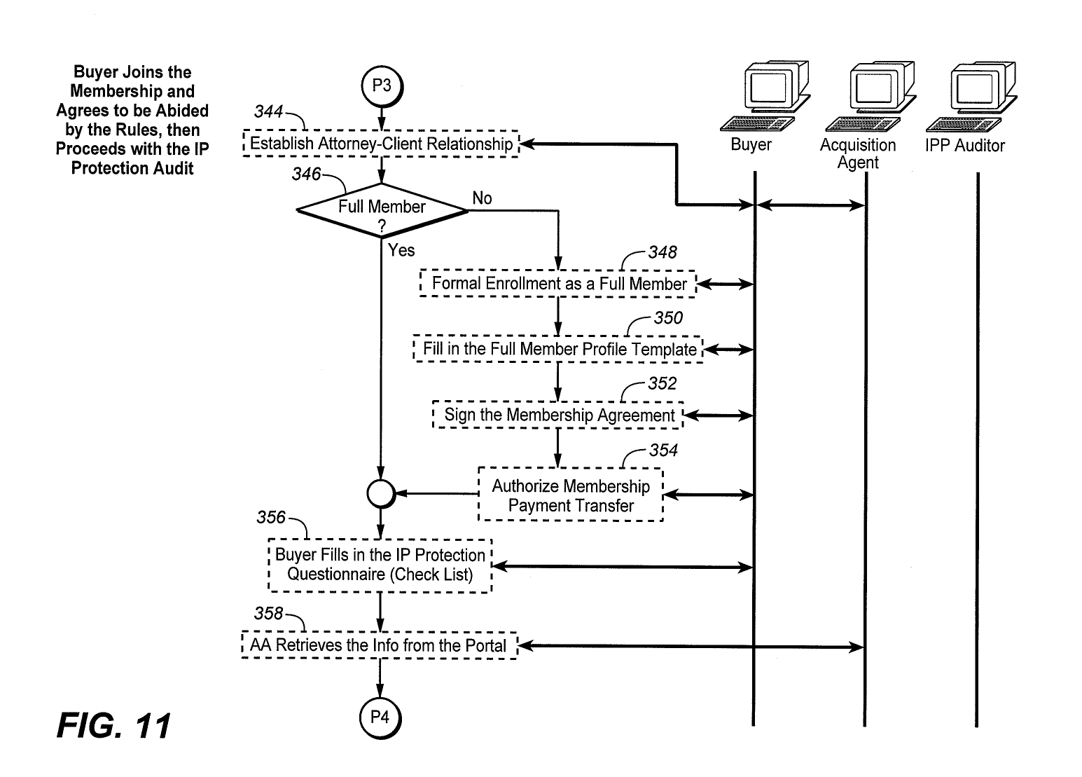

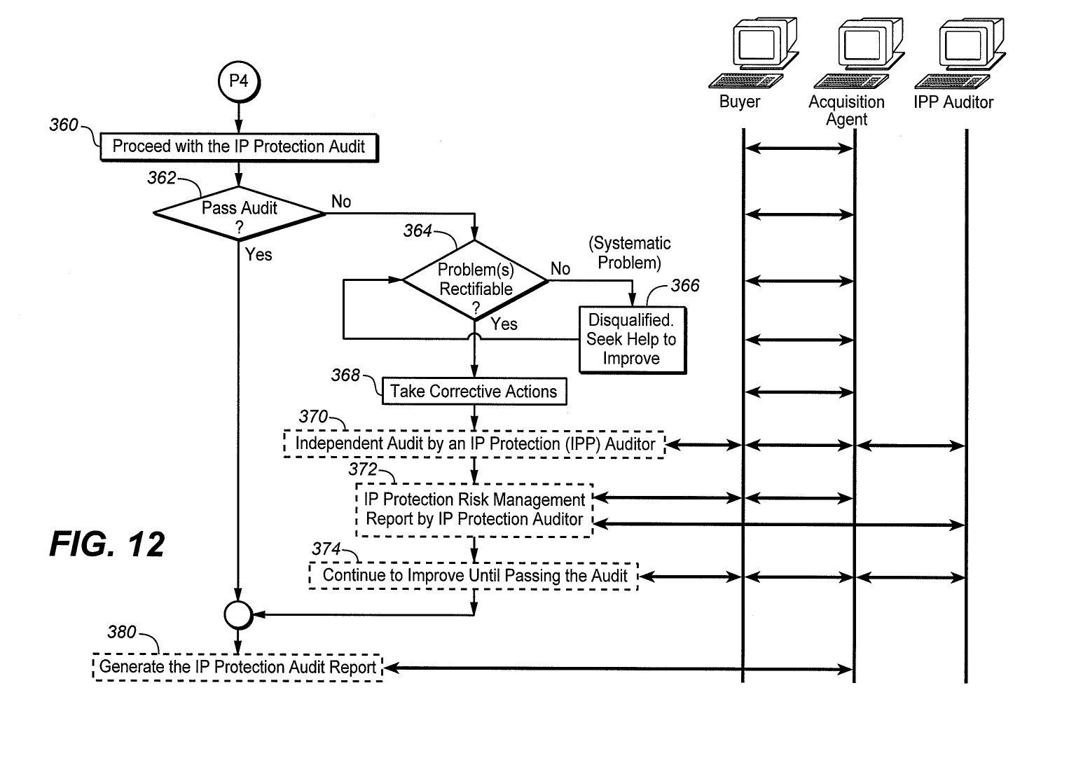

FIGS. 9-12 illustrate a flow chart for buyer qualification process. The process by which the user logs in, creates new user name and password, providing information in response to IP questionnaire, and business information/goal template, company profile template are substantially the same as those described above for the seller in FIG. 4, so that the operations in blocks or diamonds 302-320 are substantially similar to blocks or diamonds 102-120 of FIG. 4 except that now it is the buyer rather than the seller that is involved.

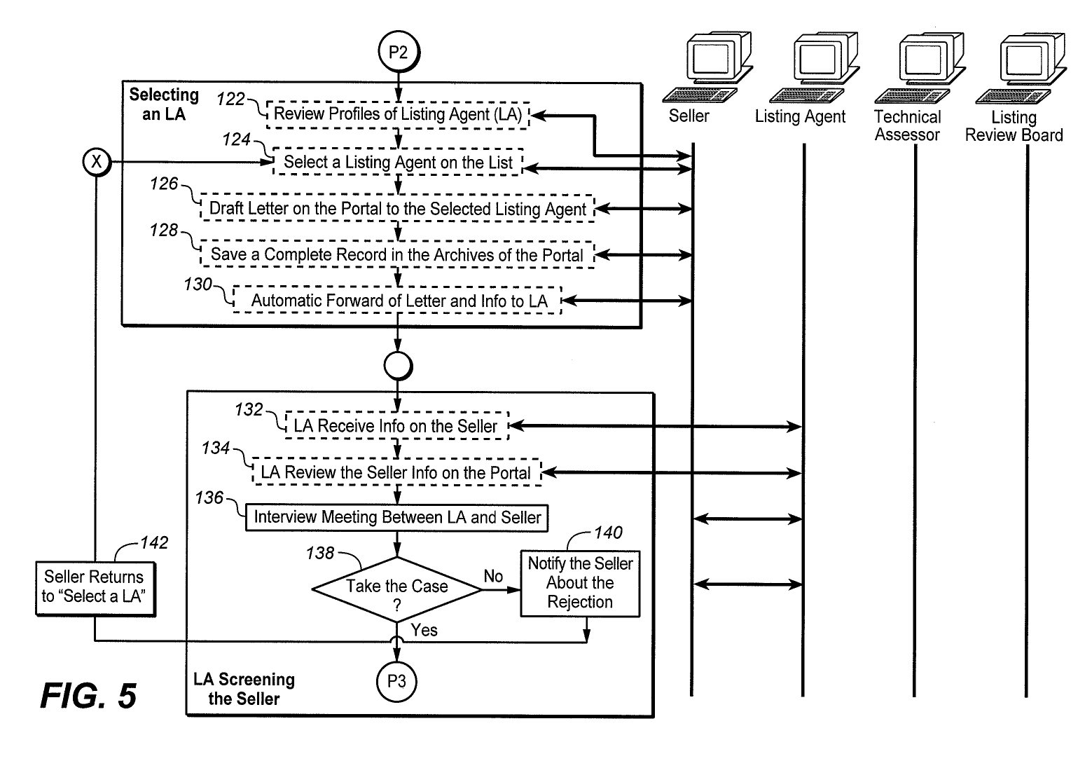

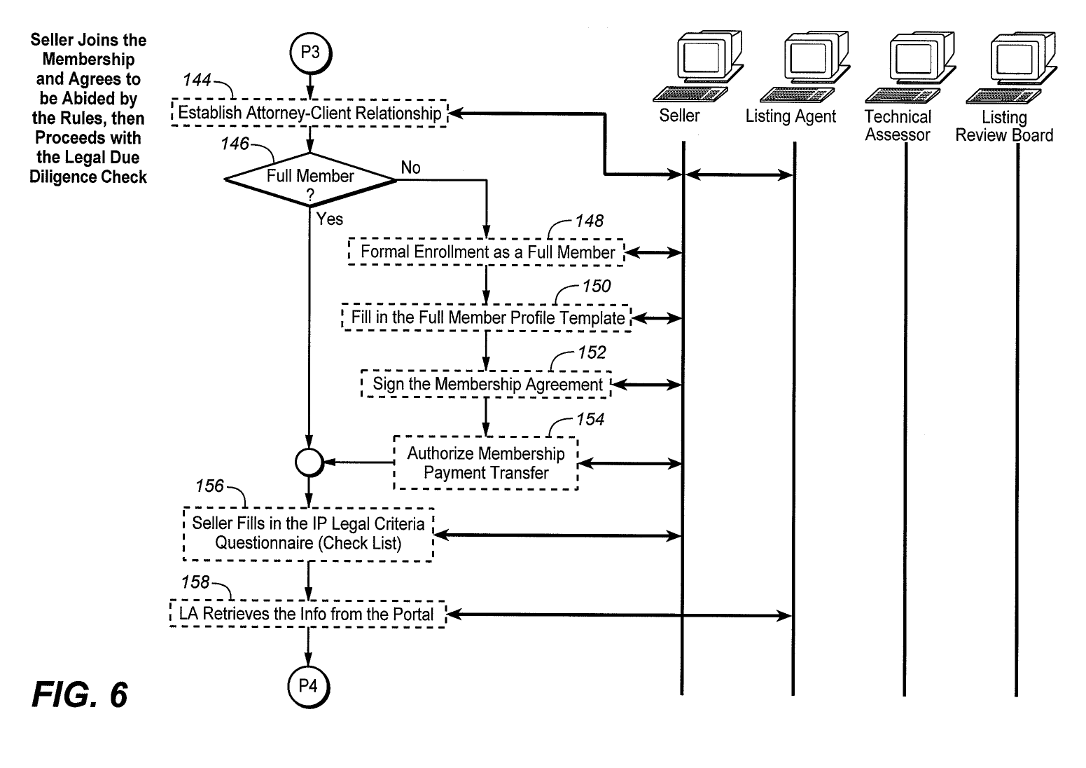

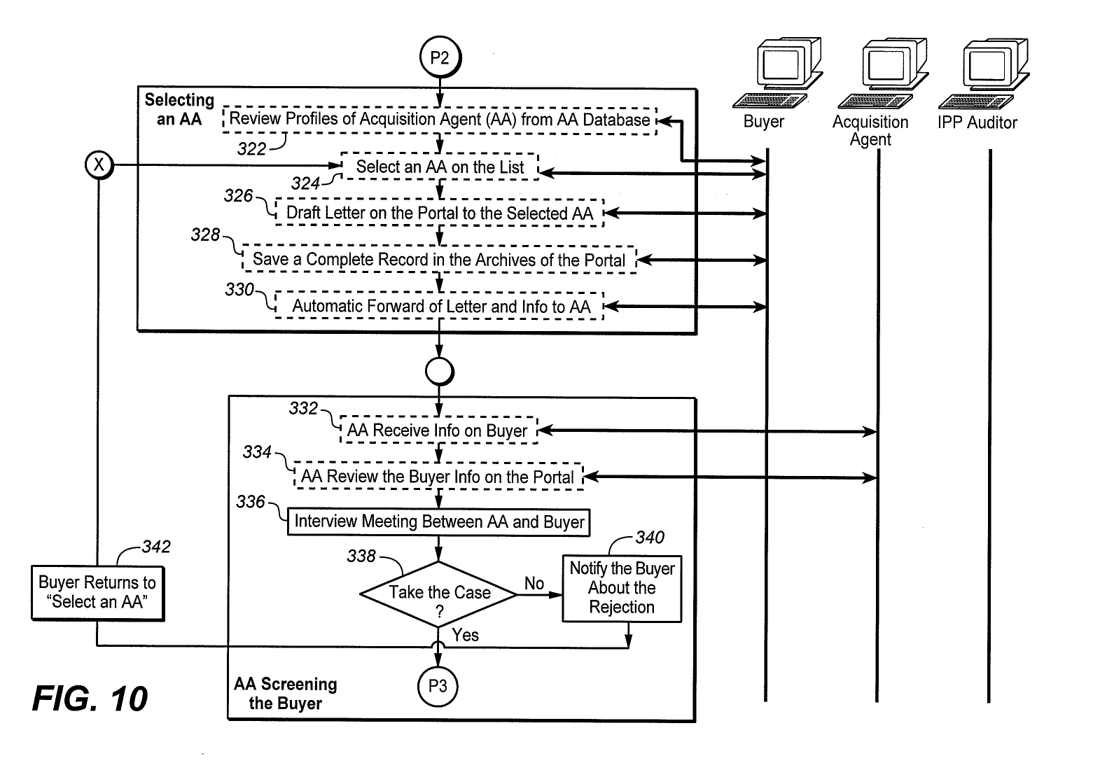

The process of the buyer selecting an acquisition agent in blocks 322-330 in FIG. 10 is also substantially similar to the process described above in blocks 122-130 for the seller in FIG. 5 in selecting a listing agent. After an acquisition agent is selected as indicated in block 330, the acquisition agent receives information on the buyer that is stored in user database 12 (block 332). The acquisition agent reviews the buyer information on the web portal (block 334) and interviews the buyer either through the web portal or in a manner independent of the web portal (block 336). The web portal then inquires the acquisition agent as to whether the acquisition agent is taking the case (diamond 338). If the acquisition agent rejects the buyer, the web portal then notifies the buyer about the rejection (block 340), and the buyer returns to block 324 to select another acquisition agent that is in user database 12 of the server computer 10. If the acquisition agent decides to take the case, an attorney client relationship is established using a reference agent engagement agreement in agreement database 14 (block 344). The buyer is then asked whether it is a full member of the IP trading organization (diamond 346). If the buyer is not a full member, then the buyer is then enrolled as a full member, and the buyer signs the membership agreement and authorizes membership payment in the same manner as described above for the seller in FIG. 6 (blocks 348, 350, 352 and 354).

The web portal then presents an IP protection questionnaire to the buyer to be filled in (block 356). The buyer fills in the questionnaire and provides the information to the web portal and the acquisition agent retrieves the information from the buyer in response to the questionnaire from the portal (block 358).

The acquisition agent then proceeds with the IP protection audit to determine whether the buyer qualifies for buying IP rights. For example, the IP protection audit may inquire as to whether the buyer has adequate internal procedures in place to provide adequate protection of confidential information of the seller (block 360). The web portal on server computer 10 inquires as to whether the buyer passes the audit (diamond 362). If the buyer fails to pass the audit, the server computer inquires as to whether the problem is rectifiable (diamond 364). If the problem is not rectifiable, the buyer is disqualified and is also notified to such effect and the process ends (block 366). If the problem is rectifiable, the buyer with the assistance of the acquisition agent takes corrective actions (block 368). Such actions are recorded by the web portal at the server computer 10. All of the information provided by the buyer, including corrective actions that may have been taken, are provided to an IP protection (IPP) auditor (block 370). The auditor performs an independent audit of the qualifications of the buyer and generates an IP protection risk management provision report (block 372) using a report template in template file 20. The auditor's report may call for additional improvements by the buyer. The buyer, with the optional assistance of the acquisition agent, continues to improve its qualifications until it passes the audit (block 374). The acquisition agent then generates the IP protection audit report (block 380). If the buyer passes the audit at diamond 362, the above described actions need not be taken, and the acquisition agent can proceed to generate the IP protection audit report

IP Transfer and Payment Process

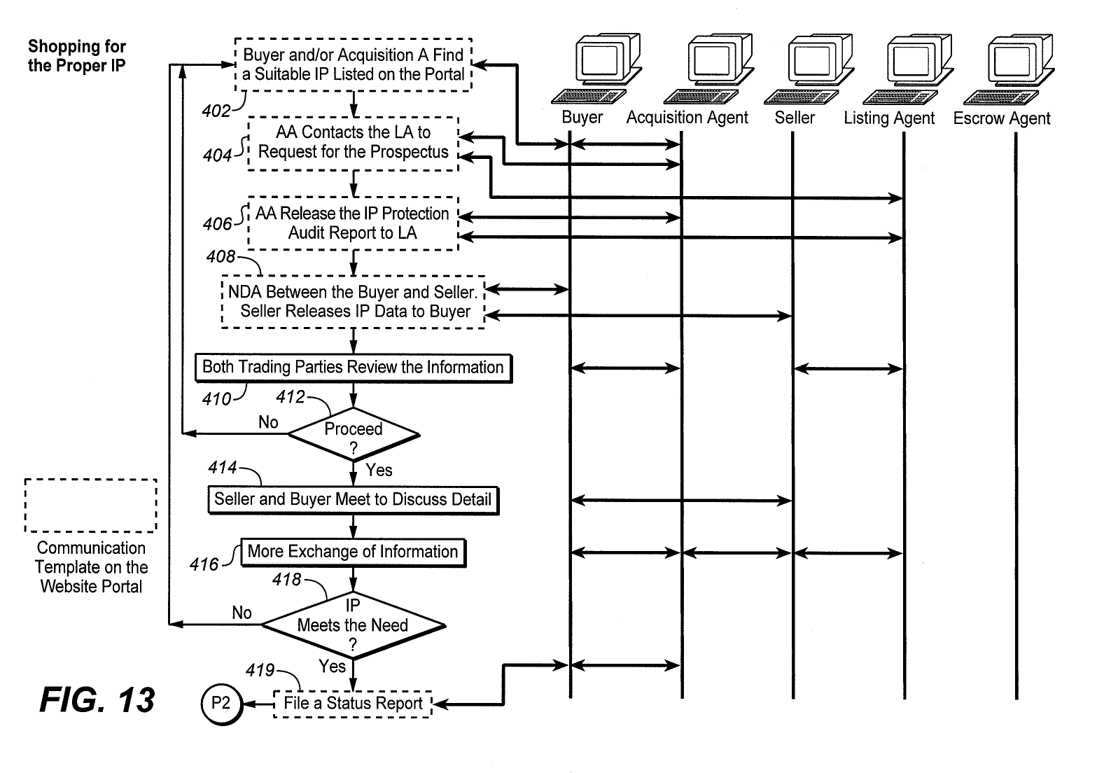

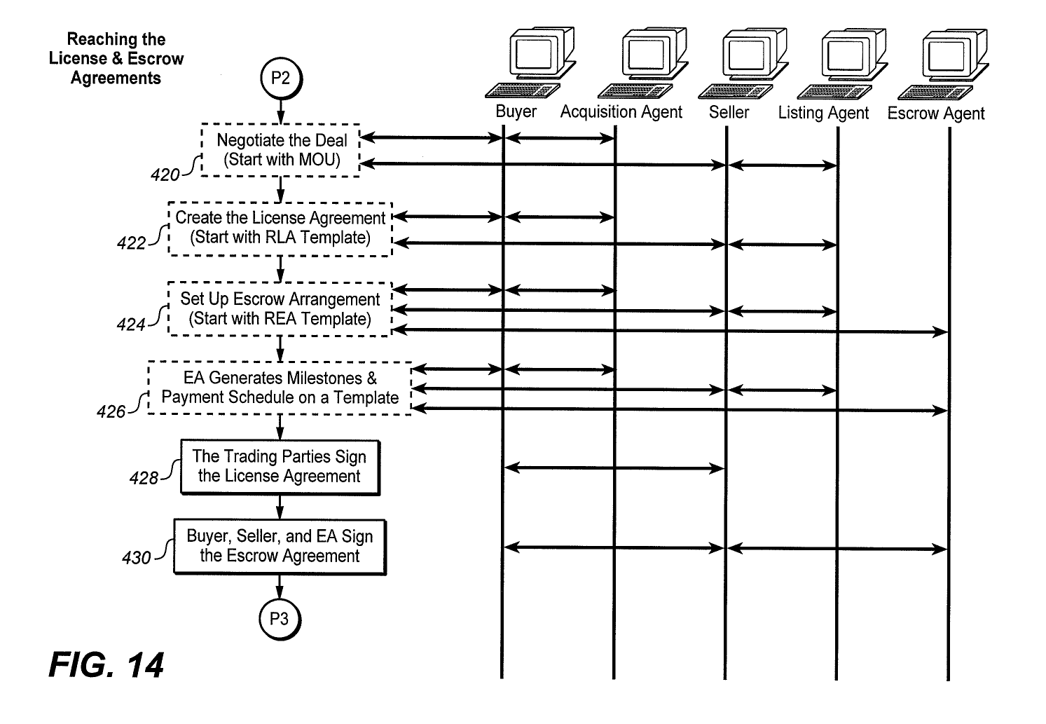

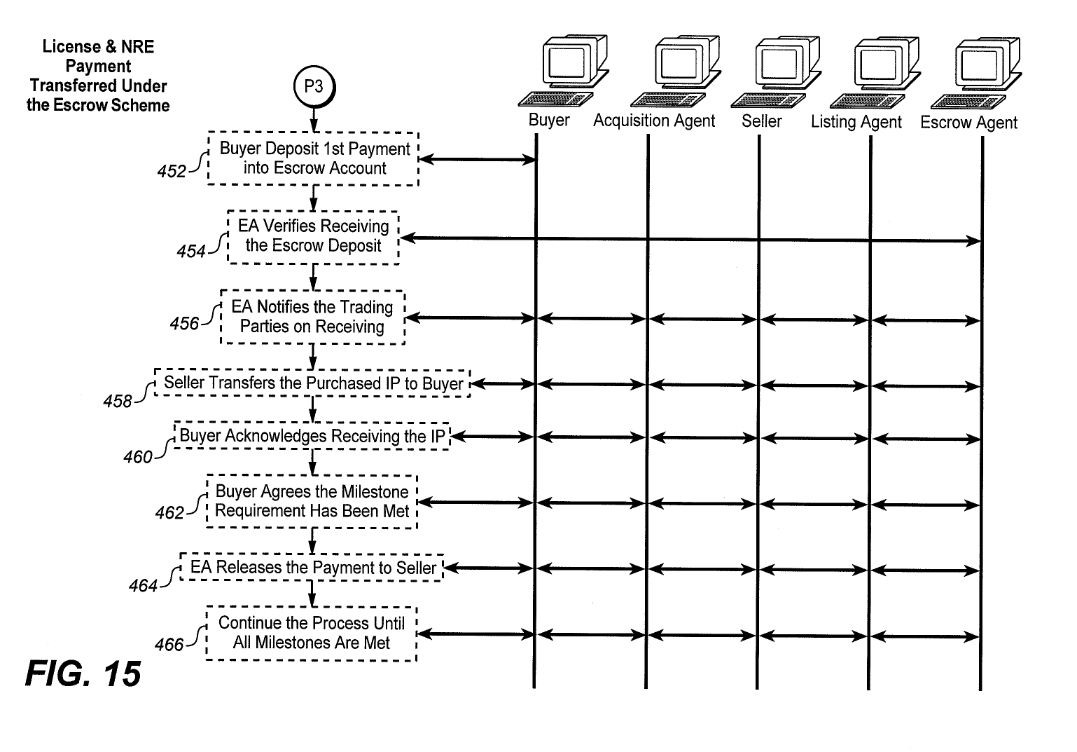

This process is illustrated in the flow chart of FIGS. 13-15. The buyer and/or acquisition agent first finds a suitable IP listed in the user database 12 in the server computer 10 (block 402). The acquisition agent then contacts the listing agent to request the IPL prospectus (block 404). The acquisition agent releases the IP protection audit reports to the listing agent (block 406) and an NDA is signed between the buyer and the seller (block 408). The seller then releases data on the IP of interest to the buyer. The seller and buyer then each reviews the information received from the other party (blocks 410). After such review, both the buyer and seller determine whether to proceed as prompted by the web portal (diamond 412). If either one or both parties determine not to proceed, the system returns to block 402. If both parties determine to proceed, the buyer and seller then meet to discuss details of the transaction either through the web portal or in a manner independent of the web portal (block 414). The two parties exchange information and the buyer determines whether the IP meets its needs (block 416 and diamond 418). If the IP does not meet the needs of the buyer, the buyer returns to block 402 to review other IP listed on the portal. If the IP does meet the needs of the buyer, the buyer or the acquisition agent files a status report to so indicate (block 419).

If the IP of the seller does meet the needs of the buyer, the buyer and seller then negotiate an IP transaction starting with an MOU using a MOU template provided in the reference agreements file 14 on the server computer 10 (block 420). A license agreement is then generated using the reference license agreement (RLA) template in reference agreements file 14 (block 422). An escrow arrangement is then set up using the reference escrow agreement (REA) template in agreements file 14 (block 424). An escrow agent is selected who generates a schedule of milestones and payment using a template provided by reference agreements file 14 on the server computer (block 426). This schedule may be attached as an attachment to the escrow agreement. The two parties then sign the license agreement (block 428). The buyer, seller and the escrow agent then sign an escrow agreement (block 430) with a schedule of milestones and payment as an attachment. The milestones in the schedule may include deliverables such as design files to be transferred from the seller to the buyer. For some applications, payment to the seller may be contingent upon delivery of such deliverables.

To carry out the terms and conditions of the escrow agreement, the buyer first deposits the first payment into an escrow account at the escrow agent (block 452). The escrow agent verifies that the payment has been received (block 454) and notifies the trading and other parties that the escrow deposit has been received (block 456). The seller then transfers the purchased IP rights to the buyer (block 458) according to the terms of the escrow agreement and the schedule of milestones and payment. The buyer acknowledges receiving the IP at the portal (block 460). The buyer agrees and notifies the parties through the portal that the milestone requirement has been met (block 462). The escrow agent then releases the payment (or a part of it, depending on the terms of the escrow agreement) made by the buyer to the seller (block 464). The above-described process is then carried out in accordance with the schedule of milestones and payments attached to the escrow agreement until all milestones are met and all payments have been made (block 466).

The actions and functionalities of the web portal hosted by the server computer may be implemented in software. When computer system 60 is used as the server computer, main memory 66 stores information and instructions to be executed by processor 64 for implementing the actions and functionalities of the web portal. Main memory 66 also may be used for storing temporary variables or other intermediate information during execution of these instructions by processor 64. The read only memory (ROM) and/or other static storage device 68 also stores static information and instructions for processor 64.

For additional security, the transfer of information between the web portal and users may be encrypted, using any one of the commercially available techniques of encryption, such as symmetric keys or asymmetric keys. Examples of the asymmetric keys that may be used include PGP (Pretty Good Privacy) and those provided for in the public key infrastructure (PKI).

Three Independent Branches

The above embodiments may be placed in a larger context for IP trading. Useful for the IP market is the creation of a check-and-balance system with the least possible conflicts of interest by employing independent third party supports to properly balance the interests of the trading partners with full transparency. There are three independent branches comprising this system. One entity creates the rules and oversees the overall system, such as the rules for membership, such as the three types of membership described above. A second facilitates the SIP transactions. And the third helps settle disputes in an efficient, cost-effective, speedy and impartial manner preferably through arbitration. This is in analogy with the three branches of most governments: legislative, executive and judicial.

The various embodiments described above comprise the second branch that facilitates the SIP transactions. One important element in the IP trading embodiments of the second branch is codifying what is contained in the transferred “IP Package” and what is documented. In addition, it creates mechanisms for effective communication between buyers and sells; for tracking progress of transactions; and for more efficient dispute resolution.

While infrastructure of the second branch described above will be valuable for the worldwide marketplace, it may initially be used to address safe trading between technologically advanced regions and developing regions—especially regarding IP protection issues.

While the invention has been described above by reference to various embodiments, it will be understood that changes and modifications may be made without departing from the scope of the invention, which is to be defined only by the appended claims and their equivalents.

1. A method performed by a seller computer for qualifying intellectual property of a seller for trading through a web portal and a network between the web portal, the seller computer and at least one listing agent computer, comprising:
logging in the web portal;
communicating with the at least one listing agent computer to engage an intellectual property rights listing agent;
supplying information for an intellectual property rights audit; and
receiving an intellectual property rights audit report.

2. The method of claim 1, further comprising displaying said intellectual property rights audit report on a computer monitor or printing said intellectual property rights audit report using a printer.

3. The method of claim 1, further comprising presenting information to said web portal for an intellectual property listing prospectus for listing the intellectual property rights for trading with potential buyers when the intellectual property rights audit report indicates that the intellectual property meets a listing criterion.

4. The method of claim 1, said network connecting a server computer hosting the web portal, the seller computer, at least one listing agent computer and at least one technical assessor computer, said method further comprising communicating with the at least one technical assessor computer to select and engage a technical assessor, and supplying to the at least one technical assessor computer information for a technical assessment of the intellectual property, and receiving a technical assessment report.

5. The method of claim 1, further comprising enrolling the seller as a member of a trading organization, wherein being a member of the trading organization is required prior to listing the intellectual property rights for trading.

6. A computer system for qualifying intellectual property of a seller for trading through a web portal and a network between the web portal, the computer system and at least one listing agent computer, said computer system comprising at least one computer program performing the following:
logging in the web portal;
communicating with the at least one listing agent computer to engage a listing agent;
supplying information for an intellectual property rights audit; and
receiving an intellectual property rights audit report.

7. The computer system of claim 6, further comprising a monitor displaying the intellectual property rights audit report.

8. The computer system of claim 6, said at least one computer program further performing the following:
presenting information to said web portal for an intellectual property listing prospectus for listing the intellectual property rights for trading with potential buyers when the intellectual property rights audit report indicates that the intellectual property meets a listing criterion.

9. The computer system of claim 6, said network connecting a server computer hosting the web portal, the seller computer, at least one listing agent computer and at least one technical assessor computer, said at least one computer program further performing the following:
communicating with the at least one technical assessor computer to select and engage a technical assessor, and supplying to the at least one technical assessor computer information for a technical assessment of the intellectual property, and receiving a technical assessment report.

10. The computer system of claim 6, said at least one computer program further performing the following:
enrolling the seller as a member of a trading organization, wherein being a member of the trading organization is required prior to listing the intellectual property rights for trading.

11. A method performed by a server computer hosting a web portal for qualifying intellectual property of a seller for trading through the web portal and a network between the server computer, a seller computer and at least one listing agent computer, comprising:
in response to a request from the seller computer, supplying profiles of listing agents;
supplying an intellectual property rights legal criteria questionnaire to the seller computer; and
after a listing agent has been engaged by the seller, supplying the selected listing agent through said at least one listing agent computer information provided by the seller computer in response to the intellectual property rights legal criteria questionnaire.

12. The method of claim 11, further comprising storing an activity log of all activities on a time sequence basis.

13. The method of claim 11, further comprising performing role based access control for all computers that log in to the web portal.

14. The method of claim 11, further comprising supplying the seller computer an intellectual property listing prospectus questionnaire in response to a request from the seller computer.

15. The method of claim 14, said network connecting the server computer, the seller computer, at least one listing agent computer and at least one listing review board computer, said method further comprising receiving from the seller computer or the at least one listing agent computer an intellectual property listing prospectus and providing said prospectus to the at least one listing review board computer.

16. The method of claim 15, further comprising listing on the web portal the intellectual property when the intellectual property listing prospectus is approved for listing.

17. The method of claim 11, said network connecting a server computer hosting the web portal, the seller computer, at least one listing agent computer and at least one technical assessor computer, said method further comprising providing a template to at least one technical assessor computer to enable a technical assessor to perform a technical due diligence check on the intellectual property of the seller and generate a technical assessment report.

18. A computer system hosting a web portal for qualifying intellectual property of a seller for trading through a web portal and a network between the computer system, a seller computer and at least one listing agent computer, said computer system comprising at least one computer program performing the following:
in response to a request from the seller computer, supplying profiles of listing agents;
supplying an intellectual property rights legal criteria questionnaire to the seller computer; and
after a listing agent has been engaged by the seller, supplying the selected listing agent through said at least one listing agent computer information provided by the seller computer in response to the intellectual property rights legal criteria questionnaire.

19. The computer system of claim 18, said at least one computer program further performing the following:
supplying the seller computer an intellectual property listing prospectus questionnaire in response to a request from the seller computer.

20. The computer system of claim 19, said network connecting the server computer, the seller computer, at least one listing agent computer and at least one listing review board computer, said at least one computer program further performing the following:
receiving from the seller computer or the at least one listing agent computer an intellectual property listing prospectus and providing said prospectus to the at least one listing review board computer.

21. The computer system of claim 20, said at least one computer program further performing the following:
listing on the web portal the intellectual property when the intellectual property listing prospectus is approved for listing.

22. The computer system of claim 18, said network connecting computer system, the seller computer, the at least one listing agent computer and at least one technical assessor computer, said at least one computer program also causing a template to be provided to at least one technical assessor computer to enable a technical assessor to perform a technical due diligence check on the intellectual property of the seller and generate a technical assessment report.

23. A method performed by a buyer computer for qualifying a buyer for trading intellectual property rights through a web portal and a network between the web portal, the buyer computer and at least one acquisition agent computer, comprising:
logging in the web portal;
communicating with the at least one acquisition agent computer to engage an intellectual property rights acquisition agent;
supplying information for an intellectual property protection audit; and
receiving an intellectual property protection audit report.

24. The method of claim 23, further comprising displaying said intellectual property rights audit report on a computer monitor or printing said intellectual property rights audit report using a printer.

25. The method of claim 23, further comprising enrolling the buyer as a member of a trading organization, wherein being a member of the trading organization is required prior to buying intellectual property rights.

26. A computer system for qualifying a buyer for trading intellectual property rights through a web portal and a network between the web portal, the buyer computer and at least one acquisition agent computer, said computer system comprising at least one computer program performing the following:
logging in the web portal;
communicating with the at least one acquisition agent computer to engage an intellectual property rights acquisition agent;
supplying information for an intellectual property protection audit; and
receiving an intellectual property protection audit report.

27. The computer system of claim 26, further comprising a monitor displaying the intellectual property protection audit report.

28. A method performed by a server computer hosting a web portal for qualifying a buyer for trading intellectual property rights through a web portal and a network between the server computer, a buyer computer and at least one acquisition agent computer, comprising:
in response to a request from the buyer computer, supplying profiles of acquisition agents;
supplying an intellectual property protection questionnaire to the buyer computer; and
after an acquisition agent has been engaged by the buyer and after information has been provided by the buyer computer in response to the intellectual property protection questionnaire, supplying the selected acquisition agent through said at least one acquisition agent computer the information provided by the buyer computer in response to the intellectual property protection questionnaire.

29. The method of claim 28, said network connecting the server computer, the buyer computer, the at least one acquisition agent computer and at least one intellectual property protection auditor computer operated by an intellectual property protection auditor, further comprising supplying the at least one intellectual property protection auditor computer information supplied by the buyer in response to the intellectual property protection questionnaire.

30. The method of claim 29, further comprising posting for access by the buyer computer and the at least one acquisition agent computer an intellectual property protection risk management report by the intellectual property protection auditor, after said report has been received from the at least one intellectual property protection auditor computer.

31. The method of claim 30, further comprising posting for access by the buyer computer, the at least one acquisition agent computer and the at least one intellectual property protection auditor computer any improvement made by the buyer on intellectual property protection in response to the report.

32. The method of claim 31, further comprising posting an intellectual property protection audit report from the at least one acquisition agent computer or the at least one intellectual property protection auditor computer after the buyer passes an audit by said intellectual property protection auditor.

33. The method of claim 28, further comprising storing an activity log of all activities on a time sequence basis.

34. The method of claim 28, further comprising performing role based access control for all computers that log in to the web portal.

35. A computer system hosting a web portal for qualifying a buyer for trading intellectual property rights through the web portal and a network between the computer system, a buyer computer and at least one acquisition agent computer, said computer system comprising at least one computer program performing the following:
in response to a request from the buyer computer, supplying profiles of acquisition agents;
supplying an intellectual property protection questionnaire to the buyer computer; and
after an acquisition agent has been engaged by the buyer and after information has been provided by the buyer computer in response to the intellectual property protection questionnaire, supplying the selected acquisition agent through said at least one acquisition agent computer the information provided by the buyer computer in response to the intellectual property protection questionnaire.

36. The computer system of claim 35, further comprising a monitor displaying the intellectual property protection audit report.

37. The computer system of claim 35, said network connecting the server computer, the buyer computer, the at least one acquisition agent computer and at least one intellectual property protection auditor computer operated by an intellectual property protection auditor, further comprising supplying the at least one intellectual property protection auditor computer information supplied by the buyer in response to the intellectual property protection questionnaire.

38. The computer system of claim 37, further comprising posting for access by the buyer computer and the at least one acquisition agent computer an intellectual property protection risk management report by the intellectual property protection auditor, after said report has been received from the at least one intellectual property protection auditor computer.

39. The computer system of claim 38, further comprising posting for access by the buyer computer, the at least one acquisition agent computer and the at least one intellectual property protection auditor computer any improvement made by the buyer on intellectual property protection in response to the report.

40. The computer system of claim 39, further comprising posting an intellectual property protection audit report from the at least one acquisition agent computer or the at least one intellectual property protection auditor computer after the buyer passes an audit by said intellectual property protection auditor.

41. A method performed by a first computer operated by or on behalf of a buyer in trading intellectual property with a seller through a web portal and a network between the web portal, the first computer, a second computer operated by or on behalf of the seller, comprising:
logging in the web portal;
after an intellectual property has been identified to be of interest, communicating with the second computer to request a listing prospectus for the intellectual property;
communicating with the second computer concerning the signing of a trading agreement involving the intellectual property between the seller and the buyer; and
communicating with the second computer concerning the signing of an escrow agreement between the seller, buyer and an escrow agent for implementing the trading agreement.

42. The method of claim 41, wherein the first computer is operated by an acquisition agent.

43. The method of claim 41, wherein the second computer is operated by a listing agent.

44. The method of claim 41, wherein the communicating with the second computer to request the listing prospectus for the intellectual property occurs prior to the signing of the trading agreement.

45. A first computer system operated by or on behalf of a buyer in trading intellectual property with a seller through a web portal and a network between the web portal, the first computer, a second computer operated by or on behalf of the seller, said first computer system comprising at least one computer program performing the following:
logging in the web portal;
after an intellectual property has been identified to be of interest, communicating with the second computer to request a listing prospectus for the intellectual property;
communicating with the second computer concerning the signing of a trading agreement involving the intellectual property between the seller and the buyer; and
communicating with the second computer concerning the signing of an escrow agreement between the seller, buyer and an escrow agent for implementing the trading agreement.

46. A method performed by an escrow agent computer for trading rights to intellectual property through a web portal and a network between the web portal, a buyer computer, a seller computer, a listing agent computer, an acquisition agent computer, and the escrow agent computer, comprising:
logging in the web portal;
after a trading agreement involving the intellectual property between the seller and the buyer has been signed, communicating with the buyer computer, the seller computer, the acquisition agent computer and the listing agent computer concerning signing of an escrow agreement between the seller, buyer and an escrow agent for implementing the trading agreement;
after the escrow agreement involving the intellectual property between the seller and the buyer has been signed, and after at least one escrow payment is received from the buyer, providing verifying notices of receipt of said at least one escrow payment;
after acknowledgement by the buyer computer that a milestone regarding transfer of rights to the intellectual property has been met and after at least one escrow payment is received from the buyer, authorizing release of at least part of an escrow payment from the buyer.

47. The method of claim 46, further comprising presenting a schedule for payment and milestones as a part of the escrow agreement.

48. An escrow agent computer for trading intellectual property rights through a web portal and a network between the web portal, a buyer computer, a seller computer, a listing agent computer, an acquisition agent computer, and the escrow agent computer, said escrow agent computer system comprising at least one computer program performing the following:
logging in the web portal;
after a trading agreement involving the intellectual property rights between the seller and the buyer has been signed, communicating with the buyer computer, the seller computer, the acquisition agent computer and the listing agent computer concerning signing of an escrow agreement between the seller, buyer and an escrow agent for implementing the trading agreement;
after the escrow agreement involving the intellectual property rights between the seller and the buyer has been signed, and after at least one escrow payment is received from the buyer, providing verifying notices of receipt of said at least one escrow payment;
after acknowledgement by the buyer computer that a milestone regarding transfer of rights to the intellectual property has been met and after at least one escrow payment is received from the buyer, authorizing release of at least part of an escrow payment from the buyer.

49. A computer system enabling intellectual property trading, comprising:
a database containing information on an intellectual property listing, sellers or their representatives; and
reference license and escrow agreements.

50. The method of claim 49, further comprising a database containing information on escrow agents.
